(19) United States
(12) Patent Application Publication
(10) Pub. No.: US 2010/0275715 A1
(43) Pub. Date: Nov. 4, 2010

(54) SHIFT CABLE ASSEMBLY AND CONNECTOR THEREFOR

(75) Inventor: Gregory P. Ruhlander, Hannibal, MO (US)

Correspondence Address: REISING ETHINGTON P.C., P O BOX 4390, TROY, MI, 48099-4390, US

(73) Assignee: DURA GLOBAL TECHNOLOGIES, INC., Rochester Hills, MI (US)

(21) Appl. No.: 12/434,316

(22) Filed: May 1, 2009

(51) Int. Cl. F16C 1/14

(52) U.S. Cl. 74/473.15; 74/502.4

(57) ABSTRACT

One implementation of a shift cable assembly may include a conduit, a core received within the conduit, a rod coupled to an end of the core a slide tube within which a portion of the rod is received and a connector. The connector may have a plastic housing disposed about an end of the rod, a first insert carried by a portion of the plastic housing, a body, a second insert carried by the body, and a fastener interconnecting the first and second inserts. The first and second inserts may engage each other to hold the plastic housing and the body in fixed positions with respect to each other.

### TECHNICAL FIELD

The present disclosure relates generally to a shift cable assembly and more particularly to a shift cable assembly and a connector therefor.

### BACKGROUND OF THE DISCLOSURE

Motion-transmitting remote control cable assemblies, sometimes referred to as “Bowden cables” or “push-pull cables,” are used for transmitting both force and travel along a curved path in aircraft, automotive, and marine environments. Known cable assemblies can be used for transmitting load and motion in push, pull and/or rotary type applications. In the automotive environment, typical applications may include but are not limited to parking brakes, accelerators, hood releases, brake releases, trunk releases, seat controls, park lock, tilt wheel controls, fuel filler doors, transmission shifter cables, powered actuators, and hydraulic control cables.

A motion-transmitting remote control cable assembly for transmitting motion along a curved path typically includes a flexible core element slidably enclosed within a flexible outer sheath (conduit) with end fittings attached to both ends of each respective member. These fittings attach and react to load from the conduit to its mounting points and from the core element to its mounting points. The core element is adapted at one end to be attached to a member to be controlled whereas the other end is attached to an actuator for moving the core element within the outer sheath. The outer sheath is adapted to be secured by the fittings to a support structure.

### SUMMARY OF THE DISCLOSURE

One implementation of a transmission shifter assembly for a vehicle includes a shift lever movable among a plurality of positions and a shift cable assembly including a core operably coupled to the shift lever, a conduit in which at least a portion of the core is received, a rod coupled to the core, and a fitting adapted to be connected to a control arm of a transmission shifter to couple the shift lever to the control arm. The cable assembly may further include a connector having a plastic housing carried by the rod, a first insert carried by the plastic housing, a body, a second insert carried by the body, and a fastener interconnecting the first and second inserts, whereby the first and second inserts directly engage each other to hold the plastic housing and the body in fixed positions with respect to each other.

One implementation of a shift cable assembly may include a conduit, a core received within the conduit, a rod coupled to an end of the core a slide tube within which a portion of the rod is received and a connector. The connector may have a plastic housing disposed about an end of the rod, a first insert carried by a portion of the plastic housing, a body, a second insert carried by the body, and a fastener interconnecting the first and second inserts. The first and second inserts may engage each other to hold the plastic housing and the body in fixed positions with respect to each other.

A shift cable assembly according to another implementation may include a cable including a core element, a conduit surrounding at least a portion of the core element, a rod coupled to an end of the core, and a fitting adapted to be connected to a support structure to couple the cable to the support structure. The assembly may also include a connector having a plastic housing carried by the rod opposite the core element and having an adjustment feature, a first insert carried by the adjustment feature, a body, a second insert carried by the body, and a fastener interconnecting the first and second inserts. The first and second inserts may directly engage each other to hold the plastic housing and the body in fixed positions with respect to each other, and the fastener may extend transversely relative to the axis of the rod and a direction of adjustment of the housing relative to the body.

### BRIEF DESCRIPTION OF THE DRAWINGS

The following detailed description of preferred implementations and best mode will be set forth with regard to the accompanying drawings, in which:

FIG. 1 is an overview of one implementation of a cable assembly used in a shifter assembly for a transmission application;

FIG. 2 is an enlarged view of a portion of FIG. 1 including a connector and a connector generally as shown in FIG. 1;

FIG. 3 is a side view of the connector of FIG. 2;

FIG. 4 is a perspective view of a portion of the cable assembly of FIG. 1, without the cable;

FIG. 5 is a partially exploded view of the cable assembly of FIG. 4;

FIG. 6 is an enlarged view of a plastic housing and a first insert of the cable assembly of FIG. 5;

FIG. 7 is a cross sectional view of the plastic housing and first insert of FIG. 6;

FIG. 8 is a perspective view of a body of the cable assembly FIG. 5;

FIG. 9 is a partially cross sectional view of the cable assembly as taken along line 9-9 of FIG. 4, to illustrate first and second inserts directly contacting each other;

FIGS. 10A and 10B are cross sectional views of the connector as taken along line 10-10 of FIG. 4, to illustrate lengthwise adjustment of the connector;

FIG. 11 is a partially exploded and partially sectioned view of another implementation of a cable assembly;

FIG. 12 is a cross sectional view of a plastic housing of the cable assembly of FIG. 11;

FIG. 13 is a partially cross sectional view of the cable assembly of FIG. 1 to show a fastener interconnecting first and second inserts;

FIG. 14 is partially exploded and partially sectional view of still another implementation of a cable assembly; and

FIG. 15 is perspective view of a body of the cable assembly of FIG. 14, illustrating the body having an isolator to damp vibration through the connector.

### DETAILED DESCRIPTION OF PREFERRED EMBODIMENTS

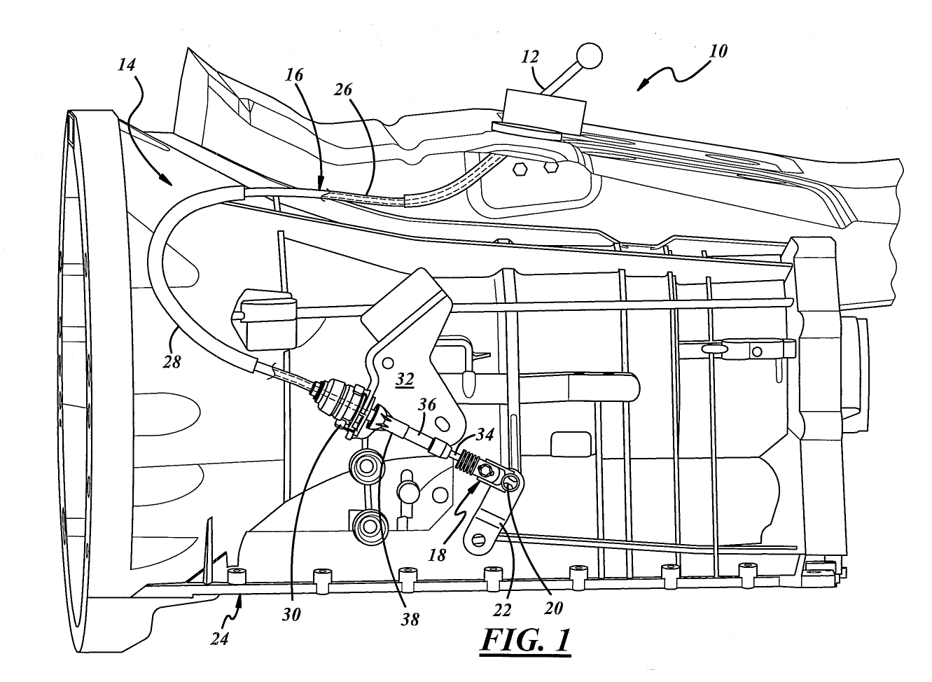

Referring in more detail to the drawings, FIG. 1 illustrates one implementation of a shifter assembly 10 having a shift lever 12 and a cable assembly 14, which may include a cable 16 and a connector 18 (“connector”). The connector 18 may be used to couple the cable 16 to a support structure or other component 20 and permit lengthwise adjustment of the cable 16 relative to the component 20 in assembly. The component 20 may be a control pin or the like that may be associated with a control arm 22 movable to shift gears in a transmission, or other feature of a vehicle transmission 24. In this manner, the shifter assembly 10 may be used in a transmission shifter application of a vehicle transmission. Of course, the shifter assembly 10 and/or the cable assembly 14 may be used in other applications.

Referring again to FIG. 1, the shift lever 12 may be located in a passenger compartment of the vehicle. The shift lever 12 may be movable to a plurality of positions that may be indicative of various gear selections or modes selected by a driver or other operator. These gear selections may include park, reverse, neutral, overdrive, first, second, a sequential upshift, a sequential downshift or any combination thereof. Of course, the shift lever 12 may indicate other selections for various automatic transmissions, semi-automatic transmissions or other human machine interfaces.

As also shown in FIG. 1, the cable 16 may include an inner core element 26 that may have one end operably coupled to the shift lever 12 so that the shift lever may move the core element 26 as a driver moves the shift lever 12 among its positions. The cable 16 may also include an outer sheath or conduit 28 that may surround at least a portion of the inner core element 26, and a rod 34 to which an end of the core 26 is coupled. The rod 34 may extend through and be received for axial reciprocation and/or rotation within a swivel or slide tube 36 or the like as is known in the art. The rod 34 may be a solid shaft with a circular cross section. Of course, the rod 34 may instead be hollow and/or have a noncircular cross section. The cable assembly 14 may further include an end fitting 30 that may couple the conduit 28 to a mounting bracket 32 which may be carried by the transmission 24. The slide tube 36 may include a shield 38.

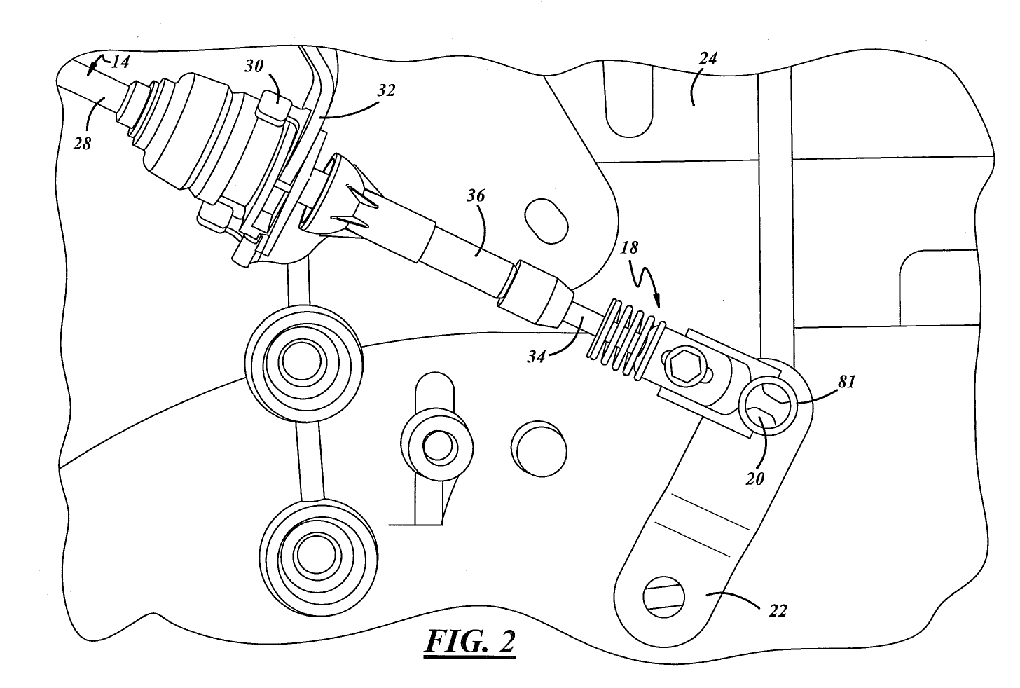

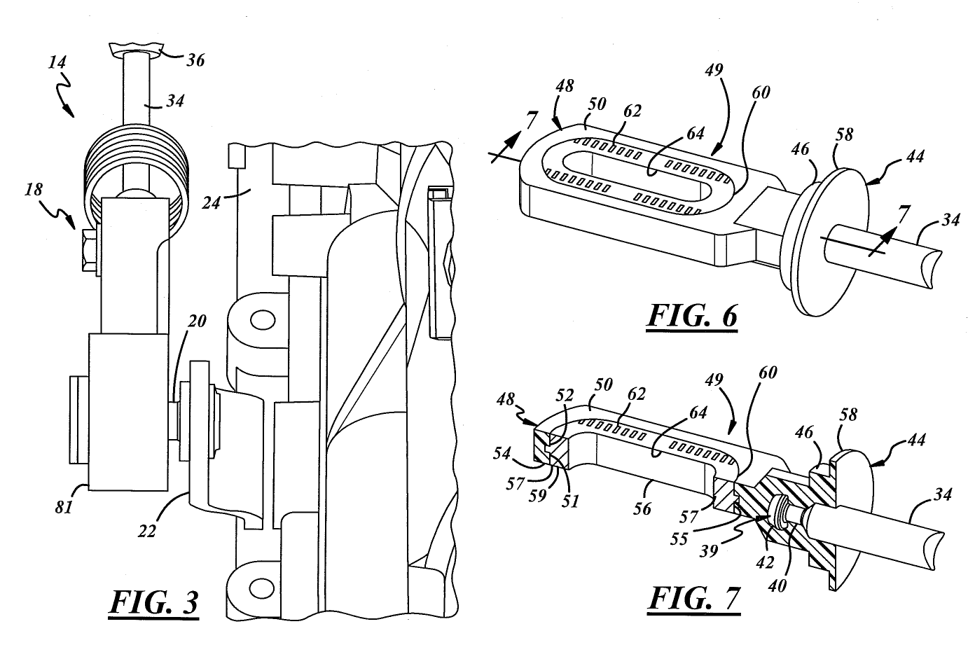

As best shown in FIGS. 2 and 7, the rod 34 may have an end opposite the inner core element, with the end having a retention feature 39. This retention feature 39 may include a reduced diameter portion 40 that may terminate with a generally circular end or circumferential flange 42 that may have a diameter that may be greater than the diameter of the reduced diameter portion 40. Of course, the retention feature 39 may instead have an opening, a slot, a hook or other noncircular retention features.

Referring again to FIG. 7, the connector 18 may also have a plastic housing 44 with a base 46 that may be carried by the retention feature 39 of the rod 34. For example, the base 46 may be disposed about an end of the rod 34 such as by, for example, overmolding the base 46 onto at least the circumferential flange 42 and the reduced diameter portion 40 to radially overlap the circumferential flange 42 of the rod 34. Of course, the housing 44 may be made of non-plastic material, and the base 46 may be press-fit, adhered, bolted or otherwise coupled to any suitable retention feature 39 of the rod 34. The base 46 may also have an annular flange 58 extending therefrom.

As also shown in FIG. 7, the housing 44 may also include a tip 48 that may extend from the base 46 opposite the rod 34 and may have an attachment or adjustment feature 49. The adjustment feature 49 in one form may include a first surface 50, a second surface 54 opposite the first surface 50 and one or more sidewalls 51 that may extend between the first and second surfaces to define a pocket 52. The pocket 52 may have an oblong shape. Of course, the pocket 52 may instead have a circular, square, rectangular, oblong or other non-circular shape as desired.

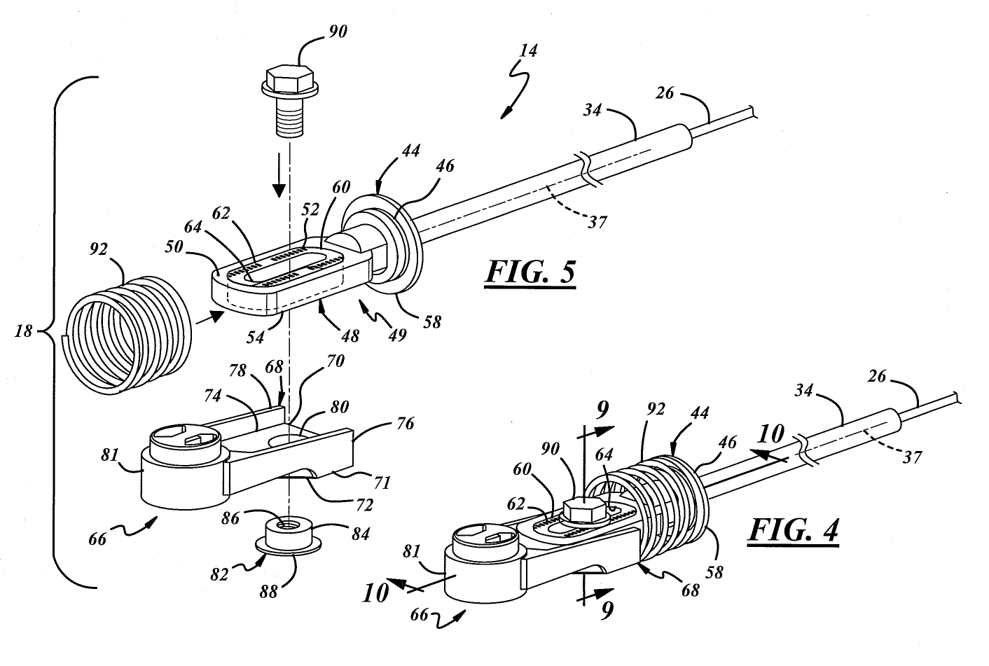

Referring to FIGS. 4 and 9, the first insert 60 may be carried by the adjustment feature 49. For example, the first insert 60 may include one or more protrusions 61 and be insert-molded within the adjustment feature 49 of the housing 44. Of course, however, the first insert may be press-fit within the pocket 52, adhered thereto or otherwise carried by the tip 48. The first insert 60 may be a washer, punched coin or other insert that may be sized and shaped to be snugly received within the pocket 52, so that at least a portion of the surfaces defining the pocket may at least partially surround and contact the insert 60. While the insert 60 may be inserted into the pocket 52 during assembly, the connector 18 may instead be overmolded, for example in successive layers, onto at least a portion of the insert 60 or otherwise coupled to the insert 60 without requiring the insert to be physically inserted into the housing 44 during assembly. As best shown in FIG. 9, the first insert 60 may have an upper side 62, a lower side 57 opposite the upper side and one or more outer surfaces 55 extending between the upper and lower sides. The outer surfaces 55 may engage at least a portion of the sidewalls 51 or other portions of the adjustment feature 49 to, for example, distribute at least a portion of a clamping load on those portions of the adjustment feature 49. The upper side 62 may have a serrated or textured surface 63, and may be generally co-planar or otherwise aligned with the first surface 50 of the tip 48. Similarly, the lower side 57 may have a serrated or textured surface 59, and may be generally co-planar or otherwise aligned with the second surface 54 of the tip 48. Of course, the upper and/or lower sides may have smooth or otherwise textured surfaces that may aligned, spaced apart or otherwise positioned relative to the surfaces of the tip 48.

In addition, the insert 60 may have an elongated aperture 64 that may extend between the upper and lower sides. The first insert 60 may be made of any suitable material, including a metal such as steel or other suitable materials that may be produced by stamping, powdered metal or other methods of manufacture. The first insert 60 may reinforce the tip 48 and may help distribute at least a portion of a load along and within the tip 48.

Referring still to FIG. 9, the connector 18 may also have a body 66 that may be associated with the tip 48 of the housing 44 in assembly. The body 66 may include a receiving portion 68 against which the tip 48 may be disposed in assembly. In one form, the receiving portion may include a tray 68 which may have a base 70 with upper and lower sides 72, 74 and a pair of opposed sidewalls 76, 78 that may extend from the base 70. Of course, other receiving portion designs, for example, without sidewalls, may be used. The tray 68 may have a width that may be generally greater than the width of the tip 48 and a depth that may be generally equal to the thickness of the tip 48 and the first insert 60, so that the sidewalls 76, 78 may engage and support the tip 48 therebetween and may limit skewing of the plastic housing 44 relative to the body 66. The body 66 may also have an opening 80 extending between the upper and lower sides 72, 74 of the base 70. In addition, the body 66 may have a portion 81 (FIG. 8) which is spaced apart from the tray 68 and constructed and arranged to releasably mate with the component 20.

As best shown in FIG. 9, the connector 18 may also have a second insert 82 that may be carried by the body 66. The second insert 82 may be included during molding of the body 66. Of course, the second insert may instead be press-fit, adhered or otherwise carried by the base 46 of the body 66 or other portions of the body. The second insert 82 may include a socket or protrusion 84 that may extend through the opening 80 of the base 70 so that the protrusion 84 may directly engage and contact the first insert 60 and/or other portions of the connector. The second insert 82 may have a threaded hole 86 that may be communicated with the elongated aperture 64 of the first insert 60 in assembly. The second insert 82 may also have a flange 88 that may extend from the protrusion 84, so that the flange 88 may engage the body 66 to, for example, limit the extent to which the second insert 82 may be inserted into the opening 80 of the body 66. The second insert 82 may be made of any suitable material, including metal such as brass or various other materials.

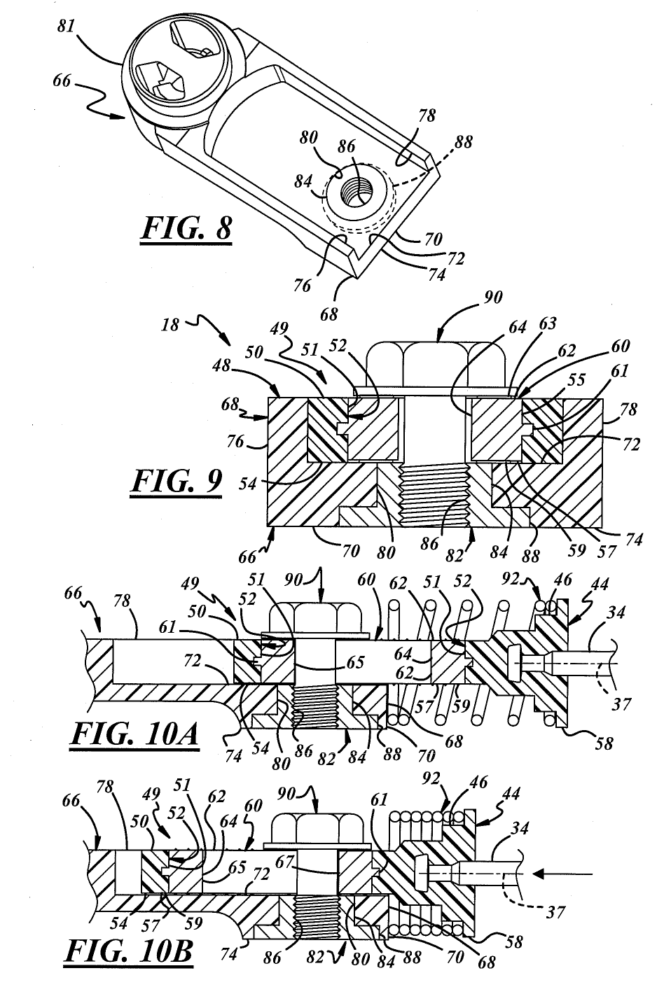

Referring still to FIG. 9, the connector 18 may also have a fastener 90 interconnecting the first and second inserts 60, 82 so that the first and second inserts directly contact each other. As shown in FIGS. 10A and 10B, the fastener 90 may extend transversely relative to the axis 37 of the rod 34 and the direction of adjustment between the housing 44 and body 66. This fastener 90 may be a threaded bolt 90 which may be inserted through the elongated aperture 64 of the first insert 60 and engaged to the threaded hole 86 of the second insert 82 to interconnect the first and second inserts 60, 82. Of course, the fastener 90 may instead be other suitable fasteners adapted to interconnect the first and second inserts 60, 82 or otherwise couple the housing 44 to the body 66.

Referring to FIGS. 10A and 10B, the connector 18 may also have a helical spring or other biasing member 92 operably associated between the plastic housing 44 and the body 66 to move the body 66 relative to the housing 44. The spring in one form may apply a force of 5 to 15 Newtons to increase the overall length of the connector 18 or apply a counterbalancing force when shortening the length of the connector 18 during assembly. Accordingly, the helical spring 92 may facilitate and stabilize lengthwise adjustment of the connector 18 in assembly. The biasing member 92 in one form is operably connected between the annular flange 58 of the housing 44 and the tray 68 of the body 66. Of course, the biasing member 92 may be associated between other suitable portions of the housing and the body.

During assembly, the connector 18 may permit lengthwise adjustment of the cable 16 relative to the component 20. In particular, the fastener 90 may be inserted through the elongated aperture 64 and loosely engaged to the threaded hole 86 of the second insert 82 to permit lengthwise movement of the tip 48 of the plastic housing 44 relative to the tray 68 of the body 66. As best shown in FIGS. 9, 10A and 10B, the tip 48 and the tray 68 may then be adjusted relative to each other between a first position in which the fastener 90 may be received within one end 65 of the elongated aperture 64 (which may extend parallel to the direction of adjustment between the tip and body) and a second position in which the fastener 90 may be received within the other end 67 of the elongated aperture 64. The fastener 90 may then be sufficiently tightened or engaged to the second insert 82 to provide metal-to-metal contact between the first and second inserts 60, 82 so that a clamping load may be primarily distributed between the inserts and not the plastic housing 44 or the body 66. This may reduce compression, creep or other deformation of various plastic portions of the connector 18 thereby increasing the rigid operable connection between the shift lever 12 and the component 20. For example, in a transmission shifter application, the connector 18 may allow a driver to operate the shift lever 12 to move the component to a desired position and select a gear as intended. Of course, it is contemplated that various suitable fasteners may be used to interconnect the first and second inserts 60, 82. In addition, the inserts, plastic housing and body may have other configurations to engage each other and distribute or take up the clamping load.

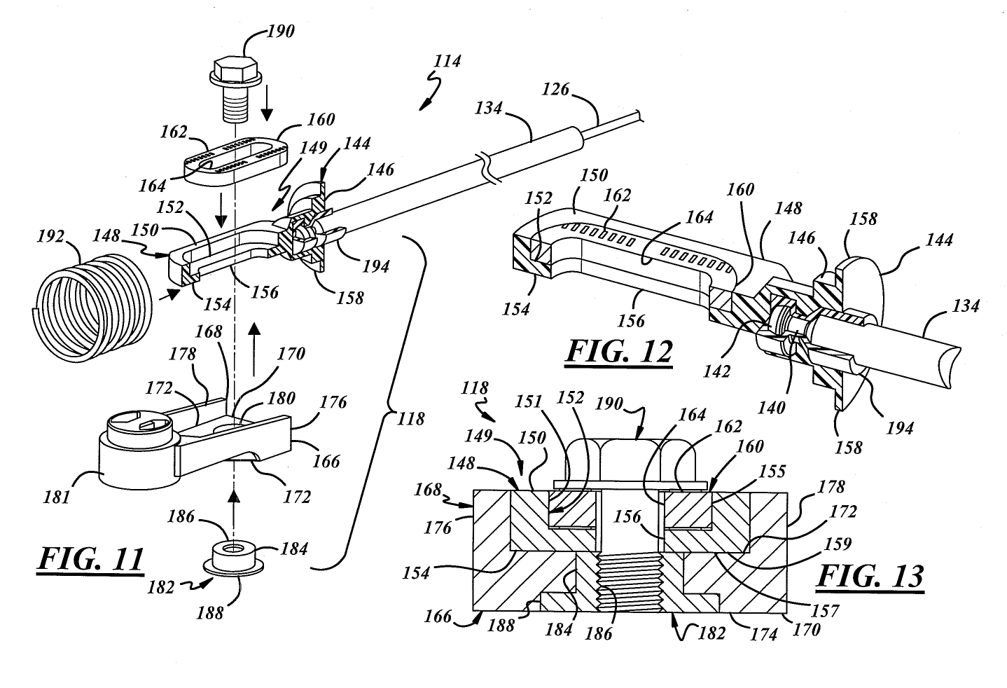

Referring to FIGS. 11 and 12, there is illustrated another implementation of a cable assembly 114 having a connector 118 with a rod 134 and a plastic housing 144. The cable assembly 114 may be similar to the cable assembly 14 of FIGS. 1 and 7 having the connector 18 with the rod 34 and plastic housing 44. However, the cable assembly 114 may also have an isolator fitting 194 overmolded onto or otherwise carried by the end of the rod 134, with the plastic housing 144 overmolded onto or otherwise carried by the isolator fitting 194 to damp vibrations within the cable assembly 114.

As best shown in FIG. 13, the housing 144 in this form may also include a tip 148 with an adjustment feature 149 that may have a first surface 150 with a pocket 152. The pocket 152 may have one or more sidewalls 151 extending from the first surface 150, with a bottom surface 153 extending between the sidewalls 151 opposite the first surface 150. The adjustment feature 149 may also have a second surface 154, with a slot 156 that may extend between the second surface 154 and the bottom surface 153 of the pocket 152. As shown in FIG. 11, the slot 156 may have a length that may be less than the length of the bottom surface 153, and a width that may be less than the width of the bottom surface 153. In addition, the pocket 152 may have an oblong shape. Of course, the pocket 52 may instead have a circular, square, rectangular, oblong or other non-circular shape as desired.

Referring still to FIG. 13, the connector 118 may also have a first insert 160 carried by the adjustment feature 149 of the plastic housing 144 to reinforce the adjustment feature 149. The first insert 160 may be press-fit within the pocket 152, included during the molding of the housing 144, adhered thereto, merely received therein without a fastener or otherwise carried by the tip 148. The first insert 160 may be a washer, punched coin or other insert sized and shaped to be snugly received within the pocket 152, so that at least a portion of the surfaces defining the pocket may at least partially surround and contact the insert 160. While the insert 160 may be inserted into the pocket 152 during assembly, the connector 118 may instead be overmolded, i.e. in successive layers, onto at least a portion of the insert 160 or otherwise coupled to the insert 160 without requiring the insert to be inserted into the housing 144 during assembly. The first insert 160 may have one or more outer surfaces 155 that may engage the sidewalls 151 or other portions of the adjustment feature 149 to, for example, distribute a clamping load on those portions of the adjustment feature 149. The first insert 160 may also have a lower side 157 with a serrated or textured surface for contacting the bottom surface 153 or other portions of the adjustment feature 149 to, for example, distribute a clamping load on those portions of the adjustment feature 149.

In addition, the first insert 160 may have a serrated or textured side 162, with an elongated aperture 164 that may extend between the textured side 162 and the other side 157 so that the elongated aperture 164 overlaps and communicates with the slot 156 of the tip 148 in assembly. The first insert 160 may be made of any suitable material, including a metal such as steel, a stamping, powdered metal or other suitable metals. The first insert 160 may reinforce the tip 148 and help distribute loads along and within the tip 148.

During assembly, the tip 148 of the plastic housing 144 may be moved lengthwise relative to the tray 168 of the body 166 between a first position in which the fastener 190 is received within one end of the elongated aperture 164 and a second position in which the fastener 190 is received within the other end of the elongated aperture 164. The fastener 190 may then be sufficiently tightened or engaged to the threaded hole 186 of the second insert 182 to clamp the housing 144 to the body 166 and distribute a clamping load among the inserts, the plastic housing 44 and the body 66. Of course, it is contemplated that various suitable fasteners may be used to interconnect the first and second inserts 60, 82. In addition, the inserts, plastic housing and body may have various other configurations engaging each other and distributing or taking up the clamping load.

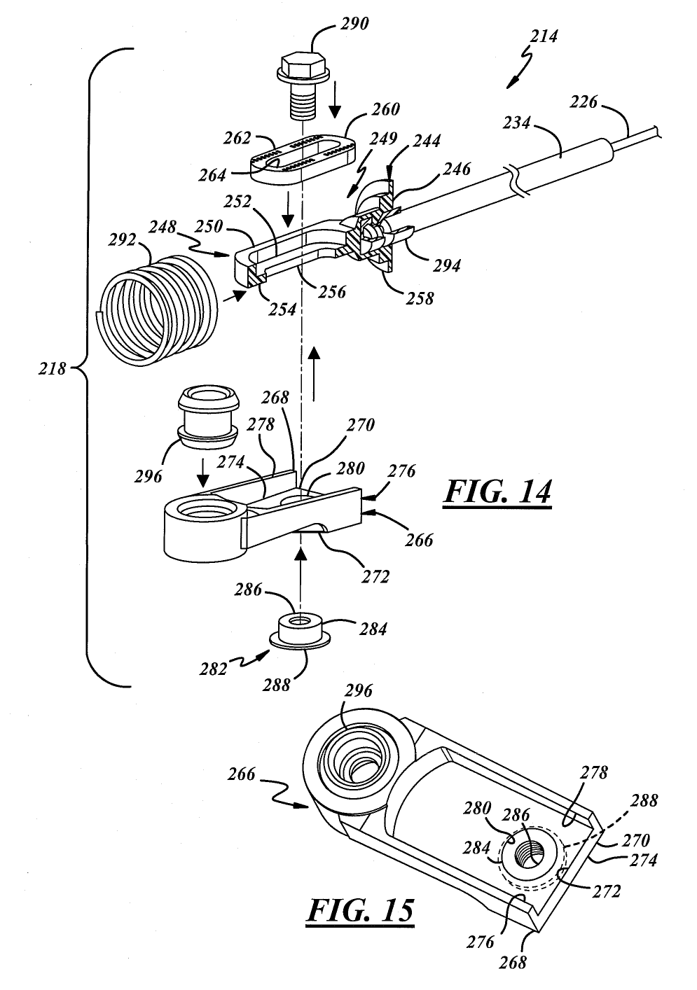

Referring to FIGS. 14 and 15, there is illustrated another implementation of a cable assembly 214 having a connector 218 (“connector”) with a body 266. The cable assembly 214 may be similar to the cable assembly 114 of FIG. 11 having the connector 118 with the body 166. However, the cable assembly 214 may also have another isolator fitting 296 carried by the end 281 of the body 266 opposite the plastic housing 244, so that the isolator fitting 296 may receive the control pin or other connector 220 and damp vibrations therebetween.

While the forms of the invention herein disclosed constitute presently preferred embodiments, many others are possible. For example, while the first and second inserts were discussed as engaging the plastic housing and body, respectively, the inserts can be transposed with the plastic housing and body configured to be supported by those inserts. Still other implementations are possible. It is not intended herein to mention all the possible equivalent forms or ramifications of the invention. It is understood that the terms used herein are merely descriptive, rather than limiting, and that various changes may be made without departing from the spirit or scope of the invention.

1. A transmission shifter assembly for a vehicle, comprising:
a shift lever movable among a plurality of positions;
a cable assembly including a core operably coupled to the shift lever, a conduit in which at least a portion of the core is received, a rod coupled to the core, and a fitting adapted to be connected to a control arm of a transmission shifter to couple the shift lever to the control arm, the cable assembly further having a connector including a plastic housing carried by the rod, a first insert carried by the plastic housing, a body, a second insert carried by the body, and a fastener interconnecting the first and second inserts, whereby the first and second inserts directly engage each other to hold the plastic housing and the body in fixed positions with respect to each other.

2. The shifter assembly of claim 1, wherein the body has an opening formed therethrough, and the second insert has a protrusion extending through the opening so that the protrusion directly engages and contacts at least one of the plastic housing and the first insert.

3. The shifter assembly of claim 1 wherein the plastic housing has a base carried by the rod and a tip extending from the base opposite the rod, and the body includes a receiving portion against which the tip is disposed in assembly and which permits adjustment of the position of the tip relative to the receiving portion so that the position of the tip relative to the body is adjustable, and wherein the first insert has an elongated aperture overlapping and in communication with an opening in the receiving portion to receive the fastener therethrough, so that the tip is adjustable and movable with respect to the tray and the fastener selectively holds the plastic housing and the body in fixed positions with respect to each other.

4. The shifter assembly of claim 3 wherein the second insert includes a protrusion extending into the opening of the receiving portion.

5. A shift cable assembly, comprising:
a conduit, a core received within the conduit, a rod coupled to an end of the core and a slide tube within which a portion of the rod is received; and
a connector having a plastic housing disposed about an end of the rod, a first insert carried by a portion of the plastic housing, a body, a second insert carried by the body, and a fastener interconnecting the first and second inserts, whereby the first and second inserts engage each other to hold the plastic housing and the body in fixed positions with respect to each other.

6. The shift cable assembly of claim 5, wherein the body has an opening formed therethrough, and the second insert has a protrusion extending through the opening so that the protrusion directly engages and contacts at least one of the plastic housing and the first insert.

7. The shift cable assembly of claim 5, wherein the second insert has a protrusion and a flange extending from the protrusion, so that that the flange engages the body to distribute at least a portion of the clamping load on the body.

8. The shift cable assembly of claim 5, wherein the plastic housing has a base carried by the rod and a tip extending from the base opposite the rod, and the body has a tray receiving the tip therein.

9. The shift cable assembly of claim 5, wherein the tray includes a base having a pair of sidewalls extending therefrom and defining a tray width, and the tip having a tip width that is less than the tray width.

10. The shift cable assembly of claim 9, wherein the sidewalls of the tray engage and support the tip to limit skewing of the plastic housing relative to the body when the fastener is applied to the first and second inserts.

11. The shift cable assembly of claim 8, wherein the tip has a pocket receiving the first insert, and the tip further has a slot communicated with the pocket and adapted to permit the fastener to pass therethrough.

12. The shift cable assembly of claim 11, wherein the first insert has an elongated aperture overlapping and in communication with the slot of the tip to pass the fastener therethrough, so that the tip is adjustable and movable with respect to the tray between a first position in which the fastener reaches one end of the elongated aperture and a second position in which the fastener reaches the other end of the elongated aperture, and the fastener selectively holds the plastic housing and the body in fixed positions with respect to each other.

13. The shift cable assembly of claim 12, wherein the connector further includes a biasing member operably associated between the plastic housing and the body to move the tip toward the first position.

14. The shift cable assembly of claim 12, wherein the plastic housing includes a circumferential flange, and the connector further includes a helical spring operably associated between the circumferential flange and the body to move the tip toward the first position.

15. The shift cable assembly of claim 8, wherein the portion of the plastic housing is an overmolded housing disposed about a connection feature of the rod.

16. The shift cable assembly of claim 8, further comprising an isolator fitting carried by the end of the rod, with the portion of the plastic housing carried by the isolator fitting.

17. A shift cable assembly, comprising:
a cable including a core element, a conduit surrounding at least a portion of the core element, a rod coupled to an end of the core, and a fitting adapted to be connected to a support structure to couple the cable to the support structure whereby the core element is movable within the conduit; and
a connector having a plastic housing carried by the rod opposite the core element and having an adjustment feature, a first insert carried by the adjustment feature, a body, a second insert carried by the body, and a fastener interconnecting the first and second inserts whereby the first and second inserts directly engage each other to hold the plastic housing and the body in fixed positions with respect to each other, and the fastener extends transversely relative to the axis of the rod and a direction of adjustment between the housing and the body.

18. The shift cable assembly of claim 17, wherein the body has an opening formed therethrough, and the second insert has a protrusion extending through the opening so that the protrusion directly engages and contacts at least one of the plastic housing and the first insert.

19. The shift cable assembly of claim 17, wherein the plastic housing has a tip with a first surface defining a pocket and a second surface defining a slot communicated with the pocket in assembly.
